(19) United States
(12) Patent Application Publication
(10) Pub. No.: US 2026/0223900 A1
(43) Pub. Date: Aug. 6, 2026

(54) EGG REPLACER COMPOSITION AND METHODS OF MAKING AND USING THE SAME

(71) Applicant: Caravan Ingredients Inc., Lenexa, KS (US)

(72) Inventor: Ashley Geoghegan Beech, Lenexa, KS (US)

(21) Appl. No.: 19/149,975

(22) PCT Filed: Feb. 22, 2024
(86) PCT No.: PCT/US2024/016910

§ 371 Date: Jul. 22, 2025

Related U.S. Application Data
(60) Provisional application No. 63/486,743, filed on Feb. 24, 2023.
(60) Provisional application No. 63/497,527, filed on Apr. 21, 2023.
(60) Provisional application No. 63/588,090, filed on Oct. 5, 2023.

(51) Int. Cl. A23L 15/00; A23J 3/18; A23L 11/00

(52) U.S. Cl. CPC A23L 15/35; A23J 3/18; A23L 11/05

(57) ABSTRACT

The present disclosure is directed to compositions comprising inter alia, a pulse flour, a soluble plant protein, a hydrocolloid, and an insoluble plant protein and use thereof, such as egg replacer compositions. This egg replacer is particularly well suited for bakery applications such as yeast-raised goods including bread, rolls, sweet baked goods, etc.

### CROSS-REFERENCE TO RELATED APPLICATIONS

The present application claims the priority benefit of U.S. Provisional Patent Application Ser. Nos. 63/486,743, filed Feb. 24, 2023, entitled EGG REPLACER COMPOSITION AND METHODS OF MAKING AND USING THE SAME; 63/497,527, filed Apr. 21, 2023, entitled EGG REPLACER COMPOSITION AND METHODS OF MAKING AND USING THE SAME; and 63/588,090, filed Oct. 5, 2023, entitled EGG REPLACER COMPOSITION AND METHODS OF MAKING AND USING THE SAME. The respective entireties of each of the foregoing applications are incorporated by reference herein.

### BACKGROUND

### Field

The present disclosure is directed to; inter alia, egg replacer compositions and methods of manufacturing, and using the egg replacer compositions as ingredients in the preparation of food products.

### Description of Related Art

Eggs are important food items and are also used as food ingredients in a plethora of food products. Eggs offer nutritional value and provide various functionalities when used as ingredients in food products. Thus, food products, including both savory and sweet goods, benefit from the inclusion of eggs. Some of the functionalities provided by eggs include texturizing, emulsifying, water retention, among others.

Many attempts have been made to create an egg replacer composition that provides the desired nutritional and functional features of eggs. Some of the deficiencies of existing egg replacers is that they can be difficult to work with and often need other ingredients to compensate for missing functionalities resulting in additional operational complexity and cost.

Thus, there is a need for an egg replacer that can be a one-for-one or direct replacement for whole eggs in baked goods requiring little to no other formulation changes. And, there is a particular need for egg replacers to be used as ingredients in food products such as bakery products.

### SUMMARY

In some embodiments, these inventors have developed an inventive egg replacer composition comprising from about 45% to about 70% of a pulse flour, from about 10% to about 25% of a soluble plant protein, from about 5% to about 15% of a hydrocolloid, and from about 3% to about 17% of an insoluble plant protein, wherein all percentages are w/w by weight of the egg replacer composition. For ease of use as a one-to-one substitution for dried whole eggs, in some embodiments, the egg replacer composition is in powdered form. In other embodiments, the weight ratio of pulse flour to insoluble plant protein in the egg replacer composition is from about 2:1 to about 25:1.

In some embodiments, the inventions include a food product comprising from about 0.01% to about 20% of an egg replacer composition comprising from about 45% to about 70% of a pulse flour, from about 10% to about 25% of a soluble plant protein, from about 5% to about 15% of a hydrocolloid, and from about 3% to about 17% of an insoluble plant protein.

In some embodiments, the inventors have also developed a method of making an egg replacer composition comprising the steps of adding from about 45% to about 70% of a pulse flour, from about 10% to about 25% of a soluble plant protein, from about 5% to about 15% of a hydrocolloid, and from about 3% to about 17% of an insoluble plant protein to a dry blender and blending until homogeneous.

In other embodiments, the inventions can include a method of adjusting a food formulation comprising the steps of replacing an amount of whole egg in the food formulation with an equal amount of an egg replacer composition comprising from about 45% to about 70% of a pulse flour, from about 10% to about 25% of a soluble plant protein, from about 5% to about 15% of a hydrocolloid, and from about 3% to about 17% of an insoluble plant protein, wherein all percentages are w/w by weight of the egg replacer composition.

In further embodiments, the disclosure provides an egg replacer composition comprising at least about 45% pulse flour, a soluble plant protein, an insoluble plant protein, and a hydrocolloid, wherein all percentages are w/w by weight of the egg replacer composition.

The disclosure also provides a method of forming a food product wherein the method comprises mixing an egg replacer composition with other ingredients to form the food product. The egg replacer composition comprises at least about 45% pulse flour, a soluble plant protein, an insoluble plant protein, and a hydrocolloid, wherein all percentages are w/w by weight of the egg replacer composition.

In yet a further embodiment, the disclosure is directed towards a food product comprising an egg replacer composition comprising at least about 45% pulse flour, a soluble plant protein, an insoluble plant protein, and a hydrocolloid, wherein all percentages are w/w by weight of the egg replacer composition.

### DETAILED DESCRIPTION

### Egg Replacer Compositions

These inventors have surprisingly found a way to replace whole eggs without recreating the composition of whole eggs including without the need for using fats or emulsifiers. According to some embodiments, an egg replacer composition comprises from about 45% to about 70% of a pulse flour, from about 10% to about 25% of a soluble plant protein, from about 5% to about 15% of a hydrocolloid, and from about 3% to about 17% of an insoluble plant protein, wherein all percentages are w/w by weight of the egg replacer composition. An egg replacer having this inventive composition has additional benefits including being acceptable to consumers who consume vegan diets and not provoking allergic reactions associated with some egg substitute ingredients such as soy, peanut, and dairy ingredients.

To be able to replace whole eggs with an egg replacer that does not include fats or emulsifiers, a careful balance of components is needed. Thus, in some embodiments, the egg replacer composition comprises pulse flour and insoluble plant protein in a w/w ratio of from about 2:1 to about 25:1, preferably about 3:1 to about 15:1, more preferably about 4:1 to about 12:1, and most preferably from about 3:1 to about 5:1. In some embodiments, the composition comprises pulse flour and insoluble plant protein in a w/w ratio of about 2:1, 2.5:1, 3:1, 5:1, 8:1, 10:1, 12:1, 15:1, 17:1, 20:1, 22:1, 23:1, or 25:1.

In some embodiments, an egg replacer composition further comprises other flours. As used herein, “other flours” can include wheat flours including whole wheat flours, semolina flour, durum flour and the like, corn flours, cereal flours, and combinations thereof. In embodiments that include other flours, the other flour can be selected for functionalities such as structural support, etc. as desired for the food product involved.

In some embodiments, an egg replacer composition as described herein is in powdered form. In some embodiments, the powdered egg replacer composition as described herein has a longer shelf-life as compared to whole egg products. For example, the egg replacer composition can be stored at ambient conditions (e.g., about 15° C. to about 30° C.) for at least about 3 months, preferably at least about 6 months, more preferably at least about 9 months, and even more preferably about 12 months to about 18 months without the egg replacer composition and/or food product containing the egg replacer composition experiencing any adverse consequences, such as spoilage and/or decrease in performance.

In some embodiments, the powdered egg replacer composition as described herein has a specific gravity of about 0.45 g/cc to about 0.65 g/cc, and preferably about 0.52 to about 0.57 g/cc as measured by specific gravity cup and weight of water.

### 1. Pulse Flour

In some embodiments, the pulse flour includes a lentil flour, a broad bean flour, a chickpea flour, a fava bean flour, a black bean flour, a kidney bean flour, a navy bean flour, a pinto bean flour, a mung bean flour, a lima bean flour, an adzuki bean flour, or combinations thereof. As used herein, “pulse flour” refers to a powder ground from grains, seeds, roots, or other sources.

In some embodiments including chickpea flour, the chickpea flour has a protein content of less than about 20% w/w, preferably from about 8% to about 20% w/w, and more preferably from about 8% to about 15% w/w of the chickpea flour. In some embodiments including chickpea flour, the chickpea flour has a total carbohydrate content of at least about 50% w/w, and preferably from about 60% to about 85% w/w by weight of the chickpea flour. In some embodiments including chickpea flour, the chickpea flour has a soluble fiber content of from about 5% to about 10% w/w by weight of the chickpea flour.

In one or more embodiments, the pulse flour comprises less than about 25% w/w total protein, preferably less than about 20% w/w total protein, and more preferably less than about 15% w/w total protein, based on the weight of the pulse flour. In the same or different embodiments, the pulse flour comprises at least about 50% w/w total carbohydrate content, preferably at least about 60% w/w total carbohydrate content, and more preferably at least about 70% w/w total carbohydrate content, based on the weight of the pulse flour.

In some embodiments, the egg replacer composition comprises at least about 45% (w/w) pulse flour, and preferably from about 45% to 70% (w/w) pulse flour. In some embodiments, the egg replacer composition comprises pulse flour in amounts of from about 45%, 50%, 55%, 60, or 65%, (w/w) to about 50%, 55%, 60%, 65% or 70% (w/w), including any range therebetween. In other embodiments, the egg replacer composition comprises pulse flour in amounts of from about 45% to about 50% (w/w), from about 45% to about 55% (w/w), from about 45% to about 60% (w/w), from about 50% to about 55% (w/w), from about 50% to about 60% (w/w), from about 50% to about 65% (w/w), from about 55% to about 60% (w/w), from about 55% to about 65% (w/w), from about 60% to about 65% (w/w), and from about 65% to about 70% (w/w) pulse flour, including any range therebetween.

In still other embodiments, the egg replacer composition comprises at least about 40% (w/w), at least about 45% (w/w), at least about 50% (w/w), at least about 55% (w/w), at least about 60% (w/w), of pulse flour, including any value therebetween.

### 2. Soluble Plant Protein

In some embodiments, the soluble plant protein includes a rice protein, a pea protein, a charantia protein, a walnut protein, a corn protein, a mung bean protein, or combinations thereof. As used herein, the term “protein” refers to organic compounds made of amino acids arranged in a linear chain. As used herein, the term “soluble plant protein” refers to a plant-based protein that dissolves within about 5 minutes in about 25° C. water at a concentration of at least 50% w/v.

In some embodiments, the weight ratio of pulse flour to soluble plant protein can be from about 0.5:1 to about 10:1, preferably about 1:1 to about 7:1, more preferably about 2:1 to about 5:1, and most preferably about 2.5:1 to about 3:1.

In some embodiments including pea protein, the pea protein has a protein content of at least about 75%. In some embodiments including pea protein, the pea protein has a viscosity of less than about 550 cps when measured by rotational viscometer in a 10-50% solution. In some embodiments, the soluble plant protein can include isolates, concentrates, or combinations thereof.

In one or more embodiments, the soluble plant protein comprises at least about 60% w/w total protein content, preferably at least about 70% w/w total protein content, more preferably at least about 80% w/w total protein content, even more preferably at least about 90% w/w total protein content, and most preferably at least about 95% w/w total protein content, based on the weight of the soluble plant protein. In the same or different embodiments, the soluble plant protein comprises less than about 25% w/w total carbohydrates, preferably less than about 15% w/w total carbohydrates, more preferably less than about 10% w/w total carbohydrates, even more preferably less than about 5% w/w total carbohydrates, and most preferably less than about 2% w/w total carbohydrates, based on the weight of the soluble plant protein.

In some embodiments, the egg replacer composition comprises from about 10% (w/w) to about 25% (w/w) of a soluble plant protein. In some embodiments, the composition comprises from about 10%, 12%, 15%, 17%, 20%, or 22% (w/w) to about 12%, 15%, 17%, 20%, 22%, or 25% (w/w) soluble plant protein, including any range therebetween. In other embodiments, the egg replacer composition comprises soluble plant protein in amounts of from about 10% to about 12% (w/w), from about 10% to about 15% (w/w), from about 10% to about 17% (w/w), from about 10% to about 20% (w/w), from about 10% to about 22% (w/w), from about 10% to about 25% (w/w), from about 12% to about 15% (w/w), from about 12% to about 17% (w/w), from about 12% to about 20% (w/w), from about 12% to about 22% (w/w), from about 12% to about 25% (w/w), from about 15% to about 17% (w/w), from about 15% to about 20% (w/w), from about 15% to about 22% (w/w), from about 15% to about 25% (w/w), from about 17% to about 20% (w/w), from about 17% to about 22% (w/w), from about 17% to about 25% (w/w), from about 20% to about 22% (w/w), from about 20% to about 25% (w/w), soluble plant protein, including any value therebetween.

In still other embodiments, the egg replacer composition comprises at least about 10% (w/w), at least about 12%, at least about 15%, at least about 17%, at least about 20%, or at least about 22% (w/w) of soluble plant protein, including any value therebetween.

### 3. Hydrocolloid

In some embodiments, the hydrocolloid can include a xanthan gum, an alginate gum, a carboxymethyl cellulose (CMC), a carrageenan gum, an agar gum, a guar gum, or combinations thereof. As used herein, the term “hydrocolloid” refers to any material that thickens and/or forms a gel when mixed with water, typically at temperature of about 25° C.

In some embodiments, the hydrocolloid includes a carboxymethyl cellulose that has a degree of substitution of from about 0.5 to about 1. In some embodiments, the hydrocolloid includes a 1% w/v solution of carboxymethyl cellulose that has a viscosity of from about 1300 to about 3500 cps when measured by rotational viscometer.

In embodiments including xanthan gum as a hydrocolloid, a 1% potassium chloride solution of the xanthan gum can have a viscosity of about 1200 to about 1600 cps.

In embodiments including guar gum as a hydrocolloid, a 1% solution of the guar gum can have a viscosity of at least about 5500 cps when measured at 25° C. after 2 hours.

In some embodiments, the egg replacer composition comprises from about 5% to about 15% of a hydrocolloid. In some embodiments, the egg replacer composition comprises from about 5%, 6%, 7%, 8%, 9%, 10%, 11%, 12%, 13%, or 14% (w/w) to about 6%, 7%, 8%, 9%, 10%, 11%, 12%, 13%, 14%, or 15% (w/w) of hydrocolloid, including any value therebetween. In other embodiments, the egg replacer composition comprises from about 5% to about 6% (w/w), from about 5% to about 7% (w/w), from about 5% to about 8% (w/w), from about 5% to about 9% (w/w), from about 5% to about 10% (w/w), from about 5% to about 11% (w/w), from about 5% to about 12% (w/w), from about 5% to about 13% (w/w), from about 5% to about 14% (w/w), from about 5% to about 15% (w/w), from about 6% to about 7% (w/w), from about 6% to about 8% (w/w), from about 6% to about 9% (w/w), from about 6% to about 10% (w/w), from about 6% to about 11% (w/w), from about 6% to about 12% (w/w), from about 6% to about 13% (w/w), from about 6% to about 14% (w/w), from about 6% to about 15% (w/w), from about 7% to about 8% (w/w), from about 7% to about 9% (w/w), from about 7% to about 10% (w/w), from about 7% to about 11% (w/w), from about 7% to about 12% (w/w), from about 7% to about 13% (w/w), from about 7% to about 14% (w/w), from about 7% to about 15% (w/w), from about 8% to about 9% (w/w), from about 8% to about 10% (w/w), from about 8% to about 11% (w/w), from about 8% to about 12% (w/w), from about 8% to about 13% (w/w), from about 8% to about 14% (w/w), from about 8% to about 15% (w/w), from about 9% to about 10% (w/w), from about 9% to about 11% (w/w), from about 9% to about 12% (w/w), from about 9% to about 13% (w/w), from about 9% to about 14% (w/w), from about 9% to about 15% (w/w), from about 10% to about 11% (w/w), from about 10% to about 12% (w/w), from about 10% to about 13% (w/w), from about 10% to about 14% (w/w), from about 10% to about 15% (w/w), from about 11% to about 12% (w/w), from about 11% to about 13% (w/w), from about 11% to about 14% (w/w), from about 11% to about 15% (w/w), from about 12% to about 13% (w/w), from about 12% to about 14% (w/w), from about 12% to about 15% (w/w), from about 13% to about 14% (w/w), from about 13% to about 15% (w/w), from about 14% to about 15% (w/w), of hydrocolloid, including any value therebetween.

In still other embodiments, the egg replacer composition comprises at least about 5% (w/w), at least about 6% (w/w), at least about 7% (w/w), at least about 8% (w/w), at least about 9% (w/w) at least about 10% (w/w), at least about 11% (w/w), at least about 12%, at least about 13% (w/w), or at least about 14% (w/w) of hydrocolloid, including any value therebetween.

### 4. Insoluble Plant Protein

In some embodiments, the insoluble plant protein is derived from a wheat flour, a rye flour, a maize flour, a barley flour, a quinoa flour, an amaranth flour, or combinations thereof. As used herein, the term “insoluble plant protein” refers to a plant-based protein that only dissolves in about 25° C. water at a concentration of less than 10% w/v, even after 10 minutes.

In some embodiments, the insoluble plant protein is a wheat gluten. In some embodiments including wheat gluten, the wheat gluten has a water binding capacity of from about 1 to about 2 ml/g. In some embodiments including wheat gluten, the wheat gluten has a protein content of from about 65% to about 80% w/w by weight of the wheat gluten.

In one or more embodiments, the insoluble plant protein comprises at least about 60% w/w total protein content, preferably at least about 70% w/w total protein content, more preferably at least about 80% w/w total protein content, even more preferably at least about 90% w/w total protein content, and most preferably at least about 95% w/w total protein content, based on the weight of the insoluble plant protein. In the same or different embodiments, the insoluble plant protein comprises less than about 25% w/w total carbohydrates, preferably less than about 15% w/w total carbohydrates, more preferably less than about 10% w/w total carbohydrates, even more preferably less than about 5% w/w total carbohydrates, and most preferably less than about 2% w/w total carbohydrates, based on the weight of the insoluble plant protein.

In some embodiments, the egg replacer composition comprises from about 3% to about 17% (w/w) of an insoluble plant protein. In some embodiments, the egg replacer composition comprises from about 3%, 5%, 8%, 10%, 12%, 14%, 15%, or 16% (w/w) to about 10%, 12%, 14%, 15%, 16%, or 17% (w/w) of an insoluble plant protein, including any value therebetween. In other embodiments, the egg replacer composition comprises from about 3% to about 5%, 5% to about 8%, 8% to about 10% (w/w), from about 8% to about 12% (w/w), from about 8% to about 14% (w/w), from about 8% to about 15% (w/w), from about 8% to about 16% (w/w), from about 8% to about 17% (w/w), from about 10% to about 12% (w/w), from about 10% to about 14% (w/w), from about 10% to about 15% (w/w), from about 10% to about 16% (w/w), from about 10% to about 17% (w/w), from about 12% to about 14% (w/w), from about 12% to about 15% (w/w), from about 12% to about 16% (w/w), from about 12% to about 17% (w/w), from about 14% to about 15% (w/w), from about 14% to about 16% (w/w), from about 14% to about 17% (w/w), from about 15% to about 16% (w/w), from about 15% to about 17% (w/w), from about 16% to about 17% (w/w) of an insoluble plant protein, including any value therebetween.

In still other embodiments, the egg replacer composition comprises at least about 3% (w/w), at least about 5% (w/w), at least about 8% (w/w), at least about 10% (w/w), at least about 12% (w/w), at least about 14% (w/w), at least about 15% (w/w), at least about 16% (w/w) of an insoluble plant protein, including any value therebetween.

In some embodiments, the weight ratio of soluble plant protein to insoluble plant protein is about 9:1 to about 0.5:1, preferably about 6:1 to about 1:1, and more preferably about 3:1 to about 1.4:1.

### 5. Hydrolytic Enzyme

In some embodiments, the hydrolytic enzyme includes a lipase, a phospholipase, a xylanase, and/or combinations thereof. As used herein, the term “hydrolytic enzyme” refers to an enzyme described as a hydrolase by the Nomenclature Committee of the International Union of Biochemistry and Molecular Biology (IUBMB) and hydrolase enzyme names include: an EC (Enzyme Commission) number in EC Class 3. Enzymes in EC Class 3 can include lipases and phospholipases (EC 3.1).

The hydrolytic enzymes of these embodiments of the inventions are not to be confused with hydrolytic enzymes commonly used in baked goods for anti-staling benefits. Anti-staling, hydrolytic enzymes can include amylases and cellulases, (EC 3.2) such as fungal amylases, bacterial alpha-amylase from Bacillus subtilis, alpha amylases, maltogenic alpha amylases, maltogenic β-amylase, non-maltogenic amylases, and like.

Various lipases including various phospholipases, triacylglycerol lipases, and galactolipases have been identified from plants; mammals; and microorganisms including but not limited to: Pseudomonas, Vibrio, Acinetobacter, Burkholderia, Chromobacterium, Cutinase from Fusarium solani (FSC), Candida antarctica A (CalA), Rhizopus oryzae (ROL), Thermomyces lanuginosus (TLL) Rhizomucor miehei (RML), Aspergillus Niger, Fusarium heterosporum, Fusarium oxysporum, Fusarium culmorum lipases.

Additionally, many lipases, phospholipases, and galactolipases have been disclosed in patents and published patent applications including, but not limited to: WO1993/000924, WO2003/035878, WO2003/089620, WO2005/032496, WO2005/086900, WO2006/031699, WO2008/036863, and WO2011/046812, each of which is incorporated by reference herein.

Suitable commercial lipases can include, but are not limited to: LIPOPAN™, NOOPAZYME, (available from Novozymes); PANAMORE®, CAKEZYME®, CAKEZYME® SUBLIME, and BAKEZYMER (available from DSM); and GRINDAMYLIM EXEL 16, GRINDAMYL™ POWERBAKE, and TS-E 861 (available from Dupont/Danisco).

Lipolytic enzyme (including lipase and phospholipase enzymes) enzyme activity can be defined in KLUs (kilo lipase units; 1000*LU), CLUs (centi lipase units; 100*LU) or LUs (lipase units) which are defined such that one LU is the amount of enzyme that will generate 1.0 μmole of glycerol from triglycerides per minute at 37° C. when measured in a colorimetric assay using a spectrophotometer using defined standard conditions.

These inventors have determined that lipolytic enzymes having an effective amount of from about 135 CLU to about 1400 CLU function well for use in these inventive egg replacer compositions. In some embodiments, the effective amount of lipolytic enzymes can be from about 135 to about 1110 CLU, or from about 275 to about 965 CLU, or from about 275 to about 690 CLU.

### 6. Cross-linking Enzyme

In some embodiments, a cross-linking enzyme can include a transglutaminase enzyme. Transglutaminases fall under the EC class 2, in particular EC 2.3.2.13. These enzymes catalyze the formation of covalent bonds between the γ-carboxamide groups of protein- or peptide-bound glutamine (acyl donors) and the free amine groups of protein- or peptide-bound lysine (acyl acceptors). Their action in forming these covalent bond tends to be irreversible, and they can serve to enhance the creation of structure in food products.

Suitable commercial transglutaminases can include VERNON® TG, ACTIVA® RM, AND TGzyme™.

Transglutaminase enzyme activity can be defined in TGU's which can be measured by the colorimetric hydroxamate test using hydroxylamine as the substrate. 1 TGU/g is defined as the amount of enzyme that will generate 1 μmol of hydroxyamic acid per minute under standardized release conditions at 37° C. and pH 6.0 with 0.2 M Tris-HCl buffer.

These inventors have determined that cross-linking enzymes having an effective amount of from about 10 to about 100 TGU function well for use in these inventive egg replacer compositions. In some embodiments, the effective amount of cross-linking enzymes can be from about 10 to about 80 TGU, or from about 20 to about 70 TGU, or from about 20 to about 50 TGU.

In some embodiments, the enzyme blend includes at least one hydrolytic enzyme and at least one cross-linking enzyme. In some embodiments, the enzyme blend has a ratio of from about 25 parts to 75 parts of at least one hydrolytic enzyme having an enzyme activity of from about 135 CLU to about 1400 CLU to about 75 parts to about 25 parts of at least one cross-linking enzyme having an enzyme activity of from about 10 to about 100 TGU. In other embodiments, the enzyme blend has a weight ratio of from about 40 parts to 60 parts of at least one hydrolytic enzyme to about 60 parts to about 40 parts of at least one cross-linking enzyme. In some embodiments the enzyme blend has a weight ratio of 50 parts hydrolytic enzyme to 50 parts cross-linking enzyme.

In some embodiments, the enzyme blend is present in the egg replacer composition in an amount of from about 0.1% to about 1.0% w/w by weight of the egg replacer composition. In some embodiments, the enzyme blend is present in the egg replacer composition in an amount of from about 0.1%, 0.2%, 0.3%, 0.4%, 0.5%, 0.6%, 0.7%, 0.8%, or 0.9% to about 0.2%, 0.3%, 0.4%, 0.5%, 0.6%, 0.7%, 0.8%, 0.9%, or 1.0% where these % are w/w by weight of the egg replacer composition.

### 7. Additional Ingredients

In some embodiments, the egg replacer composition can include additional ingredients such as colors or coloring agents, flavors or flavoring agents, fibers, bulking agents, emulsifiers, leavening agents, and/or other functional ingredients.

For example, if incorporation of the inventive egg replacer composition results in a food product with a less than desirable color because of the egg reduction in the food product, the egg replacer composition and/or the food product adjusted formulation can include a color ingredient. In some embodiments, the additional color material is an artificial and/or natural yellow and/or orange color. Additional ingredients that contribute yellow and/or orange color can include, but are not limited to a carotenoid, a lycopene, an annatto, a turmeric extract, a paprika extract, a saffron extract, a carrot extract, a sweet potato extract, a riboflavin, a curcumin (E100), an FD&C Orange B, a tartrazine (FD&C Yellow No. 5 and E102), a sunset yellow FCF (orange yellow S and FD&C Yellow No. 6 and E110), a quinoline yellow (E104), or mixtures thereof.

As to additional fibers and bulking agents, soluble and insoluble fibers can be added to improve flowability of the egg replacer composition and to enhance the textural and sensory properties of the food product. Suitable fibers and bulking agents can include, but are not limited to, inulin, arabinoxylans, psyllium husk, beta-glucan, and/or combinations thereof. In some embodiments, the additional fibers and bulking agents can include cereal fibers, brans such as oat bran, wheat bran, and the like, and/or combinations thereof. Additionally, blends of soluble and insoluble fibers can be used in some embodiments.

As to emulsifiers (also referred to as emulsifying agents), suitable materials can include polyglycerol esters, sorbitan esters, monoglycerides, mono & diglycerides, sodium stearoyl lactylate (SSL), lecithin, and the like, and/or combinations thereof.

As to leavening agents, these are materials that can cause the food products (especially baked goods) to rise or increase in volume. Suitable leavening agents can include, but are not limited to, sodium bicarbonate (i.e., as in household baking powder, alone or combined with at least one acid), yeast, sourdough starter, sodium acid pyrophosphate (also known as disodium pyrophosphate), or combinations of these materials.

Regardless of whether any such “additional ingredients” are included, in some embodiments, the disclosed egg replacer composition is substantially free of fats and oils. That is, in one or more embodiments, the egg replacer composition comprises less than about 3% (w/w) total fat and oil, preferably less than about 2% (w/w) total fat and oil, more preferably less than about 1% (w/w) total fat and oil, and even more preferably about 0% (w/w) total fat and oil.

In the same or different embodiments, the egg replacer composition is preferably free of emulsifiers (e.g., polyglycerol esters, sorbitan esters, monoglycerides, mono & diglycerides, sodium stearoyl lactylate, lecithin). Thus, in these embodiments, the egg replacer composition comprises less than about 3% (w/w) emulsifiers, preferably less than about 2% (w/w) emulsifiers, more preferably less than about 1% (w/w) emulsifiers, and even more preferably about 0% (w/w) emulsifiers.

In some embodiments, the egg replacer composition is preferably free of microalgae. As used herein, “microalgae” includes both eukaryotic microalgae, which are characterized by a nucleus, and prokaryotic microalgae, which do not have a nucleus. In these embodiments, the egg replacer composition comprises less than about 3% (w/w) microalgae, preferably less than about 2% (w/w) microalgae, more preferably less than about 1% (w/w) microalgae, and even more preferably about 0% (w/w) microalgae.

In some embodiments, the egg replacer composition is preferably free of golden flaxseed. In these embodiments, the egg replacer composition comprises less than about 3% (w/w) golden flaxseed, preferably less than about 2% (w/w) golden flaxseed, more preferably less than about 1% (w/w) golden flaxseed, and even more preferably about 0% (w/w) golden flaxseed. In some embodiments, the egg replacer composition comprises less than about 3% (w/w) flaxseed (of any kind), preferably less than about 2% (w/w) flaxseed, more preferably less than about 1% (w/w) flaxseed, and even more preferably about 0% (w/w) flaxseed.

In some embodiments, the egg replacer composition consists essentially of, or even consists of, a pulse flour, a soluble plant protein, a hydrocolloid, and an insoluble plant protein.

In other embodiments, the egg replacer composition consists essentially of, or even consists of, a pulse flour, a soluble plant protein, a hydrocolloid, an insoluble plant protein, and an enzyme.

In other embodiments, the egg replacer composition consists essentially of, or even consists of, a pulse flour, a soluble plant protein, a hydrocolloid, an insoluble plant protein, a hydrolytic enzyme, and a cross-linking enzyme.

In other embodiments, the egg replacer composition consists essentially of, or even consists of, a pulse flour, a soluble plant protein, a hydrocolloid, an insoluble plant protein, a hydrolytic enzyme, a cross-linking enzyme, and an additional ingredient chosen from coloring agents, flavoring agents, fibers, bulking agents, emulsifiers, leavening agents, or combinations thereof.

### Food Products

In addition to the egg replacer composition described herein, these inventors have also developed food product compositions that include the egg replacer composition. In some embodiments, a food product comprises about 0.01% to about 20% egg replacer composition (% w/w by weight of the food product). In other embodiments, the food product is a baked good and comprises from about 0.01% to about 10% egg replacer composition (% w/w by weight of flour in the baked good). In still other baked good embodiments, the baked good comprises from about 0.25% to about 2.50% egg replacer composition (% w/w by weight of the flour in the baked good). In these food product embodiments, the egg replacer composition comprises from about 45% to about 70% of a pulse flour, from about 10% to about 25% of a soluble plant protein, from about 5% to about 15% of a hydrocolloid, and from about 3% to about 17% of an insoluble plant protein.

In some embodiments, the egg replacer composition is a one-for-one substitute for whole eggs meaning that the formulation of the food product simply substitutes the egg replacer for the quantity of whole egg in the product formulation. This ability to make a one-for-one substitution greatly simplifies the exercise of formulation adjustment as no other changes to the food product formulation are needed. Unlike other egg replacers that require the development of a new food product formulation, the inventive egg replacer described here can be used as a direct substitute. When using the inventive egg replacer composition as a substitute for whole eggs, the amount of whole eggs can be entirely replace or it can be reduced by varying amounts. In some embodiments, the egg replace composition replaces from about 10% to about 100% of the amount of whole eggs in the food product. In other embodiments, the egg replacer composition replaces from about 20% to about 50% of the amount of whole eggs in the food product. This flexibility to use the inventive egg replacer composition as a whole or partial replacement for the whole eggs in the food product enables recipe cost adjustments based on the relative cost of whole eggs at any point in time.

Non-limiting examples of food products that can benefit from this direct substitution benefit can include baked and sweet baked goods, such as but not limited to muffins, croissants, buns, rolls, snack cakes, crackers, donuts biscuits, cookies, cupcakes, brownies, cakes including sheet cakes, pound cakes, sponge cakes, chiffon cakes, cheesecakes, fruit cakes, layer cakes and gingerbread cakes and the like, pancakes, breads, waffles, pastries, pies, tarts, scones, pretzels, and the like.

As used herein, the term “whole egg” refers to eggs products as described in 21 C.F.R. § 160.105, § 160.110, and § 160.115 or combinations thereof. Food products including the inventive egg replacer composition can have sensory properties that are not significantly different from the food products with whole eggs as measured by sensory testing. Sensory test can include typical difference tests such as duo-trio tests, triangle tests, and the like. In some embodiments, the food product has no whole egg.

A significant advantage of the disclosed egg replacer composition is that it provides structure to the food product. Food products such as baked breads show improved loaf height and/or bread volume as compared to other egg replacers. Food products such as sweet baked goods show improved air cell size, cake height, and/or cake volume as compared to other egg replacers. It will be appreciated that these properties are similar to the results achieved with real eggs.

In some embodiments, another advantageous property provided to the food products by the egg replacer composition is that of gas retention and textural attributes such as desirable elasticity including bakery products like breads, and sweet baked goods such as various types of cakes, including but not limited to pound cake, sponge cake, chiffon cake, cheesecake, sheet cake, fruit cake, layer cake, and/or gingerbread cake.

### Methods of Making and Using Egg Replacer Compositions

In some embodiments, these inventors have developed a method of making an egg replacer, with the method comprising mixing the pulse flour, soluble plant protein, hydrocolloid, insoluble plant protein, any enzymes, and any additional ingredients until homogeneous.

In one or more embodiments, this method involves combining from about 45% to about 70% of a pulse flour, from about 10% to about 25% of a soluble plant protein, from about 5% to about 15% of a hydrocolloid, and from about 3% to about 17% of an insoluble plant protein in a blender (preferably a dry blender) and blending until homogeneous. In some embodiments, an enzyme blend, a hydrolytic enzyme, a cross-linking enzyme, and/or additional ingredients can be added to the blend. These additional ingredients can include colors, flavors, fibers, bulking agents, emulsifiers, leavening agents, and/or other functional ingredients. In some embodiments, the dry blending step can include the use of various types of dry blending equipment, including but not limited to, V-blenders, ribbon blenders, paddle blenders, and the like. In some embodiments, the powder blending can be done via a batch process while in other embodiments, the powder blending can be a continuous process.

In some embodiments, the inventive methods include a method of adjusting a food formulation comprising the steps of replacing an amount of whole egg in a food formulation with an equal amount of an egg replacer composition comprising from about 45% to about 70% of a pulse flour, from about 10% to about 25% of a soluble plant protein, from about 5% to about 15% of a hydrocolloid, and from about 3% to about 17% of an insoluble plant protein, wherein all percentages are w/w by weight of the egg replacer composition.

In some embodiments, a method of making a food product includes adding from about 0.01% to about 20% w/w by weight of the food product of an egg replacer composition comprising from about 45% to about 70% of a pulse flour, from about 10% to about 25% of a soluble plant protein, from about 5% to about 15% of a hydrocolloid, and from about 3% to about 17% of an insoluble plant protein, wherein all egg replacer composition percentages are w/w by weight of the egg replacer composition to a food formulation without whole eggs. In some embodiments, the food formulation includes a muffin, a croissant, a biscuit, a cookie, a cupcake, a brownie, a cake, a pancake, a bread, a waffle, a pastry, a pie, a tart, a scone, a pretzel, or combinations thereof. In some embodiments, the method of making a food product does not require any changes to the process when using the inventive egg replacer as compared to when using whole eggs.

In some embodiments, a method of making a food product includes replacing a portion of from about 10% to about 100% of the amount of whole egg in the food product formulation with an egg replacer composition comprising from about 45% to about 70% of a pulse flour, from about 10% to about 25% of a soluble plant protein, from about 5% to about 15% of a hydrocolloid, and from about 83% to about 17% of an insoluble plant protein, wherein all percentages are w/w by weight of the egg replacer composition.

### General

The terms “comprises,” “comprising,” “includes,” “including,” “having,” and their conjugates mean “including but not limited to.”

For ranges described herein, it should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used herein the term “method” refers to manners, means, techniques, and procedures for accomplishing a given task including, but not limited to, those manners, means, techniques, and procedures either known to those of ordinary skill in the art, or readily developed from known manners, means, techniques, and procedures by those of ordinary skill in the art.

### EXAMPLES

Reference is now made to the following Examples that, together with the above descriptions, illustrate some embodiments of the invention in a non-limiting fashion.

### Example 1

### Egg Replacer Mixtures for Breads

TABLE 1
Egg Replacer Compositions for Breads

| Ingredient | Mixture 1 | Mixture 2 | Mixture 3 | Mixture 4 |
|---|---|---|---|---|
| Fava bean flour | 50 | | 60 | |
| Chickpea flour | | 56 | | 55 |
| Pea Protein | | 20 | 15 | |
| Rice Protein | 21 | | | 18 |
| CMC | 15 | 13 | 10 | 14 |
| Gluten | 14 | 11 | 15 | 13 |

All amounts are % w/w by weight of the Egg Replacer Composition

Mixtures 1-4 are prepared by adding each quantity of material to a Hobart mixing bowl and mixing at low speed for 5 minutes or until homogeneous resulting in a loose, beige powder.

### Example 2

### Bread-Type Food Product Including Egg Replacer Compositions

TABLE 2
Brioche Style Hamburger Bun

| Ingredient | Baker's % |
|---|---|
| Bread Flour | 100.00% |
| Granulated sugar | 13.00% |
| Salt | 2.00% |
| Calcium propionate | 0.25% |
| Soy oil | 3.00% |
| Wheat gluten | 2.50% |
| Egg Replacer Blend Mixtures 1-4 or Dried whole egg | 2.25% |
| Dry whey blend | 1.00% |
| Compressed yeast | 7.00% |
| Butter | 6.20% |
| Dough conditioner additive | 0.06% |
| Antistaling additive | 0.25% |
| Ascorbic acid | 0.0075% |
| Water | 61.00% |

### Work Instructions

1. Add all ingredients to McDuffy mixer set to 19° C.
2. Mix on 1st speed for 1 minute
3. Mix on 2nd speed for approximately 13 minutes until dough is fully developed.
4. Portion into approximately 60-65 gram dough pieces
5. Place into hamburger bun pan
6. Proof at approximately 105° F. (40.6° C.) and 80% RH for 55-60 minutes
7 Bake at 425° F. (218.3° C.) for 12 minutes
8. Cool for 30 minutes, then bag

Samples of brioche style hamburger buns are made using Mixtures 1-4 and compared to the same brioche style hamburger gum using dried whole egg. For brioche style hamburger bun doughs that seem too dry, additional water in amounts of 0.5-0.7% of the amount of egg replacer blend added (w/w by weight of the flour) can be added. All samples perform similarly in terms of processing and organoleptic evaluations thus demonstrating that the inventive egg replacer compositions are suitable substitutes for dried whole egg.

### Example 3

### Egg Replacer Mixtures for Sweet Goods

TABLE 3
Egg Replacer Compositions for Sweet Baked Goods

| Ingredient | Mixture 5 | Mixture 6 | Mixture 7 | Mixture 8 |
|---|---|---|---|---|
| Fava bean flour | 60 | | 60 | 6 |
| Chickpea flour | | 65 | | 55 |
| Wheat flour | 9 | | 10 | |
| Pea Protein | | 20 | 15 | |
| Rice Protein | 20 | | | 18 |
| Xanthan Gum | 4 | 5 | 10 | |
| Guar Gum | 2 | | | 4 |
| CMC | | 5 | | 10 |
| Gluten | 5 | 5 | 5 | 7 |

All amounts are % w/w by weight of the Egg Replacer Composition

Mixtures 5-8 are prepared by adding each quantity of material to a Hobart mixing bowl and mixing at low speed for 5 minutes or until homogeneous resulting in a loose, beige powder.

### Example 4

### Mini Muffin-type Sweet Goods Food Product with Egg Replacer Mixtures

TABLE 4
Mini Muffin

| Ingredient | Wt. % |
|---|---|
| Cake Flour | 16.43 |
| Granulated sugar | 17.46 |
| Muffin Base 10 2.0¹ | 10.27 |
| Sorbic acid | 0.21 |
| Potassium sorbate | 0.10 |
| Ultra Fresh Sweet 290² | 0.160 |
| Egg Replacer Composition Mixtures 5-8 | 1.85 |
| Water for Mixtures 5-8 | 5.55 |
| Dried whole egg | 11.10 |
| Corn Syrup | 4.11 |
| Glycerin | 3.08 |
| Soybean oil | 17.97 |
| Soft Touch³ | 0.92 |
| Stage 2 | |
| Water | 10.79 |
| Total | 100 |

¹This cake mix is available from Corbion
²This non-staling enzyme blend is available from Corbion
³This emulsifier is available from Corbion

### Mixing & Baking Instructions:

1. Add soybean oil, glycerin, corn syrup, Soft Touch, and water for mixtures to bowl and mix until homogeneous.
2. Add dry ingredients to bowl. Mix for 1 minute on 1st speed, then 1 minute on 2nd speed.
3. Add stage 2 water while mixing for 1 minute on 1^{st} speed, scrape well, then mix 2 minutes 1^{st} speed.
4. Pour into suitable pans and bake at 350° F. (176.7° C.) until done.

Using Mixtures 5-8 allows for a 40% reduction in the amount of whole egg.

### Example 5

### Cake-type Sweet Goods Food Product with Egg Replacer Mixtures

TABLE 5
Cake

| Ingredient | Wt. % |
|---|---|
| Granulated sugar | 27.00 |
| Vanilla Cake Base¹ | 5.00 |
| Cake Flour | 21.00 |
| Egg Replacer Composition Mixtures 5-8 | 1.40 |
| Water for Mixtures 5-8 | 4.20 |
| Stage 1 water | 7.70 |
| Dried whole egg | 8.40 |
| Soybean oil | 14.50 |
| Vanlite² | 0.80 |
| Stage 2 | |
| Water | 10.00 |
| Total | 100 |

¹This cake base mix is available from Corbion
²This emulsifier is available from Corbion

### Mixing & Baking Instructions:

1. Add oil, stage 1 water, egg replacer mixture and egg replacer mixture water, and emulsifier to mixer bowl and mix until homogeneous. Add remaining dry ingredients to bowl.
2. Mix for 1 minute on 1st speed, then 1 minute on 2nd speed
3. Add stage 2 water and mix for 1 minute on 1st speed, then 3 minutes on 2nd speed. Scrape bowl well.
4. Mix for 3 minutes on 1st speed.
5. Pour into suitable pans and bake at 350° F. (176.7° C.) until done.

### Example 6

### Egg Replacer Mixtures with Enzyme Blends

TABLE 6
Egg Replacer Compositions for Sweet Baked Goods

| Ingredient | Mixture 9¹ | Mixture 10 | Mixture 11 | Mixture 12 |
|---|---|---|---|---|
| Fava bean flour | 54 | | 58 | 5.8 |
| Chickpea flour | | 64.7 | | 52 |
| Wheat flour | 8.2 | | 8 | |
| Pea Protein | | 17 | 13 | |
| Rice Protein | 20 | | | 18 |
| Xanthan Gum | 4 | 5 | 9.6 | |
| Guar Gum | 2 | | | 4 |
| CMC | | 5 | | 10 |
| VERNON TG² | 0.3 | 0.3 | 0.6 | 0.2 |
| CAKEZYME | 0.3 | 0.7 | 0.4 | 0.5 |
| Sublime³ | | | | |
| Psyllium husk | 2 | 1 | | 1.5 |
| powder | | | | |
| Inulin | | 1 | 2 | 0.5 |
| EMPLEX⁴ | 0.2 | 0.3 | | |
| Lecithin | | | 0.4 | 0.5 |
| Gluten | 9 | 5 | 8 | 7 |

¹All amounts are % w/w by weight of the Egg Replacer Composition
²This transglutaminase is available from AB Enzymes
³This phospholipase is available from DSM
⁴This emulsifier is available from Corbion

Mixtures 9-12 are prepared by adding each quantity of material to a Hobart mixing bowl and mixing at low speed for 5 minutes or until homogeneous resulting in a loose, beige powder.

### Example 7

### Mini Muffin-type Food Product with Enzyme-containing Egg Replacer Mixtures

TABLE 7
Mini Muffin

| Ingredient | Wt. % |
|---|---|
| Cake Flour | 16.43 |
| Granulated sugar | 17.46 |
| Muffin Base 10 2.0¹ | 10.27 |
| Sorbic acid | 0.21 |
| Potassium sorbate | 0.10 |
| Ultra Fresh Sweet 290² | 0.160 |
| Egg Replacer Composition Mixtures 9-12 | 1.85 |
| Water for Mixtures 9-12 | 5.55 |
| Dried whole egg | 11.10 |
| Corn Syrup | 4.11 |
| Glycerin | 3.08 |
| Soybean oil | 17.97 |
| Soft Touch³ | 0.92 |
| Stage 2 | |
| Water | 10.79 |
| Total | 100 |

¹This cake mix is available from Corbion
²This non-staling enzyme blend is available from Corbion
³This emulsifier is available from Corbion

### Mixing & Baking Instructions:

1. Add soybean oil, glycerin, corn syrup, Soft Touch, and water for mixtures to bowl and mix until homogeneous.
2. Add dry ingredients to bowl. Mix for 1 minute on 1st speed, then 1 minute on 2nd speed.
3. Add stage 2 water while mixing for 1 minute on 1^{st} speed, scrape well, then mix 2 minutes 1^{st} speed.
4. Pour into suitable pans and bake at 350° F. (176.7° C.) until done.

Using Mixtures 9-12 allows for a 50% reduction in the amount of whole egg.

### Example 8

### Cake-type Food Product with Enzyme-containing Egg Replacer Mixtures

TABLE 8
Cake

| Ingredient | Wt. % |
|---|---|
| Granulated sugar | 27.00 |
| Vanilla Cake Base¹ | 5.00 |
| Cake Flour | 21.00 |
| Egg Replacer Composition Mixtures 9-12 | 1.75 |
| Water for Mixtures 9-12 | 5.25 |
| Stage 1 water | 7.70 |
| Dried whole egg | 7.00 |
| Soybean oil | 14.50 |
| Vanlite² | 0.80 |
| Stage 2 | |
| Water | 10.00 |
| Total | 100 |

¹This cake base mix is available from Corbion
²This emulsifier is available from Corbion

### Mixing & Baking Instructions:

1. Add oil, stage 1 water, egg replacer mixture and egg replacer mixture water, and emulsifier to mixer bowl and mix until homogeneous. Add remaining dry ingredients to bowl.
2. Mix for 1 minute on 1st speed, then 1 minute on 2nd speed
3. Add stage 2 water and mix for 1 minute on 1st speed, then 3 minutes on 2nd speed. Scrape bowl well.
4. Mix for 3 minutes on 1st speed.
5. Pour into suitable pans and bake at 350° F. (176.7° C.) until done.

Using Mixtures 9-12 allows for a 50% reduction in the amount of whole egg.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An egg replacer composition comprising from about 45% to about 70% of a pulse flour, from about 10% to about 25% of a soluble plant protein, from about 5% to about 15% of a hydrocolloid, and from about 3% to about 17% of an insoluble plant protein, wherein all percentages are w/w by weight of the egg replacer composition.

2. The egg replacer composition as in claim 1, further comprising an enzyme blend.

3. The egg replacer composition as in claim 2, wherein the enzyme blend is present in an amount of from about 0.1% to about 1.0% w/w by weight of the egg replacer composition.

4. The egg replacer composition as in claim 2, wherein the enzyme blend can include a hydrolytic enzyme, a cross-linking enzyme, or combinations thereof.

5. The egg replacer composition as in claim 4, wherein the hydrolytic enzyme can include a lipase, a phospholipase, an amylase, a xylanase, a cellulase, or combinations thereof.

6. The egg replacer composition as in claim 4, wherein the cross-linking enzyme can include a transglutaminase.

7. The egg replacer composition as in claim 1, wherein the pulse flour includes a lentil flour, a broad bean flour, a chickpea flour, a fava bean flour, a black bean flour, a kidney bean flour, a navy bean flour, a pinto bean flour, a mung bean flour, a lima bean flour, an adzuki bean flour, or combinations thereof.

8. The egg replacer composition as in claim 7, wherein the chickpea flour has a protein content of from about 15% to about 20% w/w by weight of the chickpea flour.

9. The egg replacer composition as in claim 7, wherein the chickpea flour has a total carbohydrate content of from about 60% to about 85% w/w by weight of the chickpea flour.

10. The egg replacer composition as in claim 7, wherein the chickpea flour has a soluble fiber content of from about 5% to about 10% w/w by weight of the chickpea flour.

11. The egg replacer composition as in claim 1, wherein the soluble plant protein includes a rice protein, a pea protein, a charantia protein, a walnut protein, a corn protein, a mung bean protein, or combinations thereof.

12. The egg replacer composition as in claim 1, wherein the soluble plant protein has a protein content of at least 75%.

13. The egg replacer composition as in claim 1, wherein the soluble plant protein has a viscosity of less than about 550 cps.

14. The egg replacer composition as in claim 1, wherein the hydrocolloid can include a xanthan gum, an alginate gum, a carboxymethyl cellulose, a carrageenan gum, a guar gum, an agar gum, or combinations thereof.

15. The egg replacer composition as in claim 14, wherein the carboxymethyl cellulose has a degree of substitution of from about 0.5 to about 1.

16. The egg replacer composition as in claim 14, wherein the carboxymethyl cellulose has a viscosity of from about 1300 to about 3500 cps.

17. The egg replacer composition as in claim 1, wherein the insoluble plant protein is derived from a wheat flour, a rye flour, a maize flour, a barley flour, a quinoa flour, an amaranth flour, or combinations thereof.

18. The egg replacer composition as in claim 1, wherein the insoluble plant protein is a wheat gluten.

19. (canceled)

20. The egg replacer composition as in claim 18, wherein the wheat gluten has a protein content of from about 65% to about 80% w/w by weight of the wheat gluten.

21. The egg replacer composition as in claim 1, wherein the weight ratio of pulse flour to insoluble plant protein is from about 2.3 to about 4:1.

22-39. (canceled)
